(19) United States
(12) Patent Application Publication
(10) Pub. No.: US 2021/0001873 A1
(43) Pub. Date: Jan. 7, 2021

(54) AUTONOMOUS VEHICLE DRIVING CONFIGURATION BASED ON USER PROFILE AND REMOTE ASSISTANCE IN AUTONOMOUS VEHICLE

(71) Applicant: VISTEON GLOBAL TECHNOLOGIES, INC., Van Buren Township, MI (US)

(72) Inventors: Michael K. Ingrody, Canton, MI (US); John William Whikehart, Northville, MI (US)

(21) Appl. No.: 16/460,086

(22) Filed: Jul. 2, 2019

(51) Int. Cl. B60W 50/10; G05D 1/02; B60W 50/14; G05D 1/00

(52) U.S. Cl. CPC B60W 50/10; G05D 1/0276; B60W 2050/0083; G05D 1/0088; G05D 2201/0213; B60W 50/14

(57) ABSTRACT

A system for an autonomous vehicle may include an interface configured to receive a configuration for the autonomous vehicle. The system may also include a controller configured to operate the autonomous vehicle based on the configuration. The controller may be configured to receive an update to the configuration. The controller may be configured to further operate the autonomous vehicle based on the update.

### FIELD

This disclosure relates to autonomous vehicles, and in particular, autonomous vehicles having driving configurations based on user profiles and using remote assistance.

### RELATED ART

A person may own a conventional vehicle. The person may operate and drive the conventional vehicle. Alternatively, the person may allow another person (“guest driver”) to operate and drive the conventional vehicle. For example, the guest driver may be operating and driving the conventional vehicle, and the person may be a passenger or may not be present in the conventional vehicle. The person may have reservations about the guest driver in regard to driving style. For example, the person may believe that the guest driver is too aggressive or too cautious in regard to driving style.

### SUMMARY

This disclosure relates generally to systems and methods for autonomous vehicles.

An aspect of the disclosed embodiments includes a system for an autonomous vehicle. The system may include an interface of the autonomous vehicle configured to receive a configuration for the autonomous vehicle. The system may also include a controller of the autonomous vehicle configured to operate the autonomous vehicle based on the configuration. The controller may be configured to obtain an update to the configuration. The controller may be configured to operate the autonomous vehicle based on the update.

Another aspect of the disclosed embodiments includes a system for an autonomous vehicle. The system may include a controller configured to operate an autonomous vehicle. The system may also include an interface configured to receive feedback from an occupant of the autonomous vehicle regarding the operation. The controller may be configured to respond to the occupant regarding the feedback.

Another aspect of the disclosed embodiments includes a method. The method may include receiving a configuration for an autonomous vehicle. The method may also include operating the autonomous vehicle based on the configuration. The method may further include obtaining an update to the configuration. The method may additionally include operating the autonomous vehicle based on the update.

Another aspect of the disclosed embodiments includes a method. The method may include operating an autonomous vehicle. The method may also include receiving feedback from an occupant of the autonomous vehicle regarding the operation. The method may further include responding to the occupant regarding the feedback.

### BRIEF DESCRIPTION OF THE DRAWINGS

The disclosure is best understood from the following detailed description when read in conjunction with the accompanying drawings. The various features of the drawings are not to scale. On the contrary, the dimensions of the various features are arbitrarily expanded or reduced for clarity.

FIG. 1 generally illustrates a system according to the principles of the present disclosure.

FIG. 2 generally illustrates an architecture according to the principles of the present disclosure.

FIG. 3 generally illustrates another architecture according to the principles of the present disclosure.

FIG. 4 generally illustrates a further architecture according to the principles of the present disclosure.

FIG. 5 generally illustrates a flowchart of a method according to the principles of the present disclosure.

FIG. 6 generally illustrates an architecture including a remote agent according to the principles of the present disclosure.

FIG. 7 generally illustrates a flowchart of another method according to the principles of the present disclosure.

FIG. 8 generally illustrates an occupant-initiated request method according to the principles of the present disclosure.

FIG. 9 generally illustrates a remote-agent-initiated request method according to the principles of the present disclosure.

FIG. 10 generally illustrates a vehicle according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, the following description has broad application, and the discussion of any embodiment is meant only to be an example of that embodiment, and not intended to indicate that the scope of the disclosure, including the claims, is limited to that embodiment.

One or more embodiments may improve user experience of an autonomous vehicle, for example by permitting greater customization of the driving configuration of the autonomous vehicle. This may permit the user to adapt a driving style of the autonomous vehicle to a user's preferences. In one or more embodiments an autonomous vehicle may not be limited to a default configuration.

An autonomous vehicle may include a default configuration for driving style. For example, the autonomous vehicle may, by the default configuration, be configured to drive as a performance vehicle. This may be referred to as a performance profile. In such a case, the autonomous vehicle may drive with an aggressive driving style.

The aggressive driving style may cause sudden accelerations to quickly reach a speed limit or pass a vehicle, such as by optimizing gear selection of a transmission of the autonomous vehicle to maximize power band or torque curves. This practice may operate a gear to an optimized shift point and then shift to another gear. This practice may repeat until the highest gear is reached. The aggressive driving style may cause heavy braking, such as applying full braking power to the brakes of the autonomous vehicle, early on in a braking routine, as opposed to a gradual application of the brakes. This may quickly slow the autonomous vehicle. The aggressive driving style may cause determining a travel line for negotiating a turn. For example, in the aggressive driving style, the autonomous vehicle may identify and travel through an optimal approach for entering a turn, identify and travel through an apex of the turn, and identify and travel through an optimal exit for the turn. The aggressive driving style may cause tuning of one or more systems on the autonomous vehicle to maximize speed, acceleration, power, and/or torque. For example, to optimize drag in light of a driving condition, which may be either to minimize or maximize drag depending on the driving condition, the aggressive driving style may cause adjustment to a ride height, a spoiler, a window, a body panel, or another element of the autonomous vehicle. As another example, the aggressive driving style may cause an internal combustion engine, an electric motor, of a hybrid power system for powering the autonomous vehicle to operate at a maximum power mode and/or a maximum torque mode. In the case of the internal combustion engine, this may include optimize air-fuel ratios or ignition timing to maximize power and/or torque. In the case of the electric motor, this may include shutting down or entering sleep modes for non-critical, secondary systems, which would otherwise draw energy from a power/battery pack shared with the electric motor. The aggressive driving style, however, may be undesirable for certain occupants who prefer a more docile ride.

Alternatively, an autonomous vehicle may include a conservative driving style, as the default configuration. The conservative driving style may cause slower accelerations, such as by short-shifting (i.e., shifting before an optimized shift point is reached) from a low gear to a high gear in the transmission of the autonomous vehicle. The conservative driving style may seek to minimize changes in speed or direction, which may result in restrictions on passing or lane changes. The aggressive driving style may cause light braking, such as applying braking power that gradually increases to the brakes of the autonomous vehicle. This may gradually slow the autonomous vehicle. Moreover, instead of maximizing power or torque, the conservative driving style may cause the autonomous vehicle to maximize fuel economy. As such, the conservative driving style may cause one or more systems to maximize fuel economy. (A profile of this kind may be referred to as an economy profile.) For example, in the conservative driving style, the autonomous vehicle may operate below maximum power band and torque curves, which may result in conservation of fuel. In the case of the internal combustion engine, the electric motor, of the hybrid power system, this may include limiting power or torque output to values below the maximum values. In the case of the internal combustion engine, this may include deactivating cylinders, such as by stopping fuel flow to the cylinders, or leaning out fuel concentrations in air-fuel ratios. For certain occupants, the conservative driving style may be undesirable, such as those trying to meet a close-in-time appointment or those experiencing a medical emergency. In some instances, an occupant may prefer a cautious/conservative ride generally, but may be willing to accept a more aggressive driving style when that occupant is running late for an appointment.

While the autonomous vehicle may initially be loaded with the default configuration, the autonomous vehicle may receive an updated configuration. This updated configuration may be provided a number of ways. The updated configuration may be pushed over the air (OTA) or hardwired. For example, the autonomous vehicle may receive the updated configuration from a remote device, such as a remote server, which communicates with the autonomous vehicle OTA. Alternatively, the updated configuration may be pushed from an occupant's device, such as a smartphone. The occupant's device may be connected to the vehicle with a wired connection, such as with a universal serial bus (USB) port (thus, for example, a USB connection may be an example of a hardwired connection), or a wireless connection, such as with Wi-Fi or Bluetooth. In another alternative, the autonomous vehicle may initially be loaded with the default configuration as well as a variety of further predesigned configurations and the autonomous vehicle may be capable of switching among the configurations.

The updated configuration may be based on one occupant, such as a user profile, or a group of occupants, such as averages associated with the group. Alternatively, the default configuration may be adjusted via a user interface on the autonomous vehicle or on the occupant's device.

The autonomous vehicle may further include one or more sensors for monitoring the occupant. This may allow the occupants to provide real-time feedback to alter the driving experience. For example, the occupant may be faced with a new time constraint. For example, the occupant suddenly needs to be at destination X in N minutes. In this case, the occupant may provide the autonomous vehicle with that new information and ask the autonomous vehicle to try to adjust the driving experience accordingly. An example command could be: “Vehicle, need you to pick up the pace. I need to be at X in N minutes.” This may be communicated in any desired way, such as through audible commands, via an audio system that includes a microphone in the autonomous vehicle, through a tactile user interface on the autonomous vehicle, such as a touchscreen or keyboard, or through a message from the occupant's device, such as a smart watch or smart phone.

Additionally, the autonomous vehicle may be configured to receive implicit indicators. For example, sensors in the autonomous vehicle may monitor facial expressions, audible responses, such as screams, or finger or foot tapping to try to adjust the drive experience. The sensors may be directed at or in seating positions in the autonomous vehicle. The sensors may be located within a cabin of the vehicle or externally to, but directed, at the cabin of the vehicle. For example, the sensors may be embedded into a dashboard or an A-pillar of the vehicle to monitor one or more front seats.

The autonomous vehicle may make predictions for the driving experience, which the occupant may alter. For example, if there is one adult and one child, as the occupants, the autonomous vehicle may adjust the default configuration based on data obtained from similar situations. For example, the autonomous vehicle may refer to other cases where at least one child was in the vehicle or when exactly one adult and one child were in the vehicle. This could be done from a lookup table in a local or remotely stored database. The autonomous vehicle may also use artificial intelligence, such as machine learning, to identify, recommend, implement, and/or adapt a driving behavior, which may be based on feedback from other experiences.

The occupant(s) may simply want to leave the driving experience up to the autonomous vehicle. Alternatively, the autonomous vehicle may announce, “We will be driving cautiously today,” which may provide the occupant with an opportunity to request a different approach, such as to drive as fast as possible. As another alternative, the autonomous vehicle may announce, “We will be driving as fast as safely possible today,” and an occupant may request instead, “Please conserve energy as much as possible.”

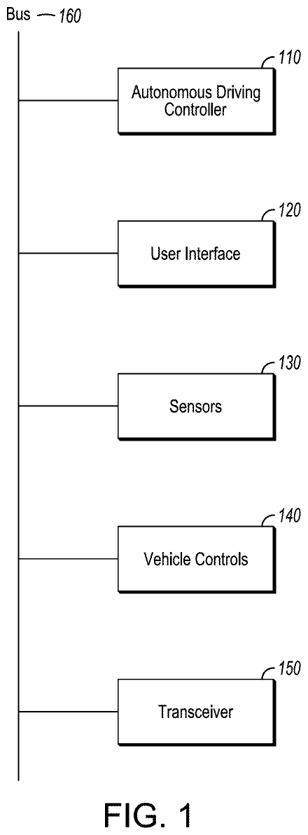

FIG. 1 illustrates a system according to one or more embodiments. As shown in FIG. 1, the system may include an autonomous driving controller 110 installed in a vehicle. The autonomous driving controller 110 may be a hardware processor running software stored in memory. The autonomous driving controller 110 may include a driving configuration governing trade-offs among such factors as the following: safety margin, fuel efficiency, performance, comfort, scenic experience, and so on. For example, each of multiple competing priorities may be weighted according to the configuration. In another approach (which may be implemented together or separately from the priority weighting approach), the system may weight individual maneuvers, such as braking versus lane changing, braking hard versus decreasing a following distance to a leading vehicle, or the like. A particular autonomous driving controller 110 may come with a default configuration or set of default configurations, such as performance, economy, and comfort. The autonomous driving controller 110 may be configured to dynamically adapt the configuration according to a user's preference. For example, the autonomous driving controller 110 may be configured to adapt a driving configuration based on live feedback from a vehicle occupant during a particular drive.

The system may also include a user interface 120, which may be a built-in keyboard, touch screen, set of buttons, or other user input mechanism. Optionally, the user interface 120 may be on a personal electronic device belonging to a vehicle occupant, which may be referred to as the occupant's device, such as a smart watch or smart phone. The user interface 120 may permit vehicle occupants to provide instructions or requests to the autonomous vehicle that implicitly or explicitly change the driving configuration. For example, an explicit command might be: “change to performance mode.” (This may imply, for example, using a performance profile as the configuration of the autonomous vehicle.) For another example, an implicit command might be: “get us to destination X as soon as possible.”

The system may also include sensors 130. The sensors 130 may be configured to monitor for implicit input from vehicle occupants. The implicit input may include signs of impatience (such as tapping fingers or tapping feet), signs of fear (such as widening eyes or white knuckles), signs of happiness (such as smiles or relaxed postures), and so on. The sensors 130 may also monitor driving behavior when a human driver is manually controlling the vehicle. The autonomous driving controller 110 or another processor, either within or external to the vehicle, may analyze the human driving behavior to allow the vehicle to mimic the driving behavior of the human driver. Thus, the human driving behavior may be used as feedback to modify a configuration of the autonomous driving controller 110. Examples of sensors include video camera systems monitoring the facial expressions, posture, and gestures of the occupants. Other examples of sensors include pressure sensors in seats of the vehicle. Other examples of sensors include touch sensors in control surfaces of the vehicle including, for example, a steering wheel of the vehicle (if one is provided) a control panel of the vehicle, or the like. Other examples of sensors can include acoustic sensors configured to measure position and/or vital signs of occupants of the vehicle.

The system may also include vehicle controls 140. These vehicle controls 140 may include control of a vehicle's braking, acceleration, and steering. The vehicle controls 140 may also include control of more detailed aspects of a vehicle's systems, such as control of a vehicle's internal combustion engine (shutting down cylinders, for example), fuel cell, or electrical drive system. For example, the vehicle controls 140 may include controlling whether and when to use regenerative braking.

The system may also include a transceiver 150. The transceiver 150 may include communication hardware and accompanying software. The transceiver 150 may be configured to communicate via wired or wireless communication protocols to a remote computing device, such as a remote server. The transceiver 150 may be configured to receive instructions to update a configuration of the autonomous driving controller 110. The transceiver 150 may also provide user feedback regarding a current or prior driving configuration to a remote server. The transceiver 150 may be connected to one or more antenna and may be configured to operate according to any desired radio access technology including, without limitation, Wi-Fi, vehicle-to-anything (V2X), third generation (3G), fourth generation (4G), Long Term Evolution (LTE), fifth generation (5G), or the like.

The various components of the system may be variously interconnected. For example, one option is for the components to be interconnected by bus 160, which may be a bus of car area network (CAN). Other implementations are also possible.

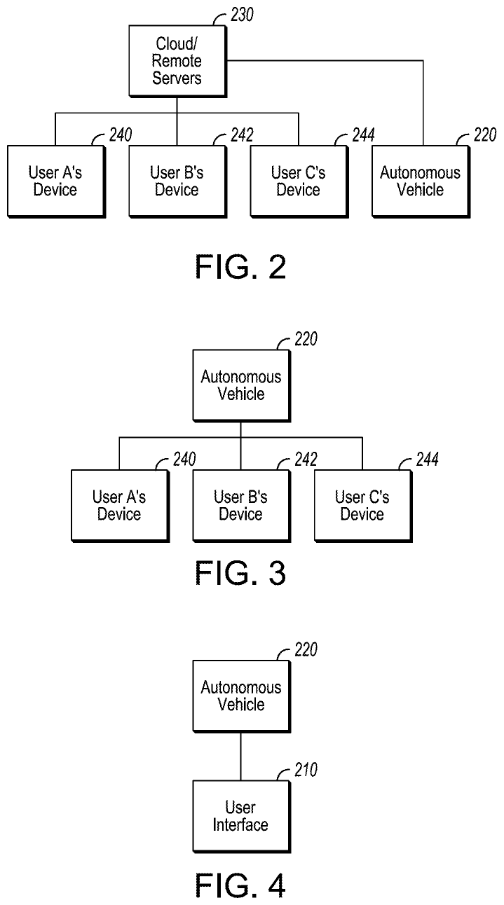

FIG. 2 illustrates an architecture according to one or more embodiments. As shown in FIG. 2, a system may include an autonomous vehicle 220, connected to cloud/remote servers 230. The cloud/remote servers 230 may be connected to user devices, which may include user A's device 240, user B's device 242, and user C's device 244. These user devices may be the same as the occupant devices discussed above. The cloud/remote servers 230 may receive instructions or feedback from the user devices and may provide an updated configuration to the autonomous vehicle 220.

FIG. 3 illustrates another architecture according to one or more embodiments. In this illustrated system, the autonomous vehicle 220 may be directly connected to the user devices, namely user A's device 240, user B's device 242, and user C's device 244. Thus, in this embodiment the user devices may directly provide instructions or feedback to the autonomous vehicle 220.

FIG. 4 illustrates a further architecture according to one or more embodiments. As shown in FIG. 4, an occupant may operate a user interface 210 and thus directly interact with an autonomous vehicle 220, thereby updating a driving configuration of the autonomous vehicle. This user interface may involve a touch screen interface, a gesture-based interface (for example, relying on one or more cameras), or the like. The architectures of FIGS. 2, 3, and 4 may be used alone or any combination with one another.

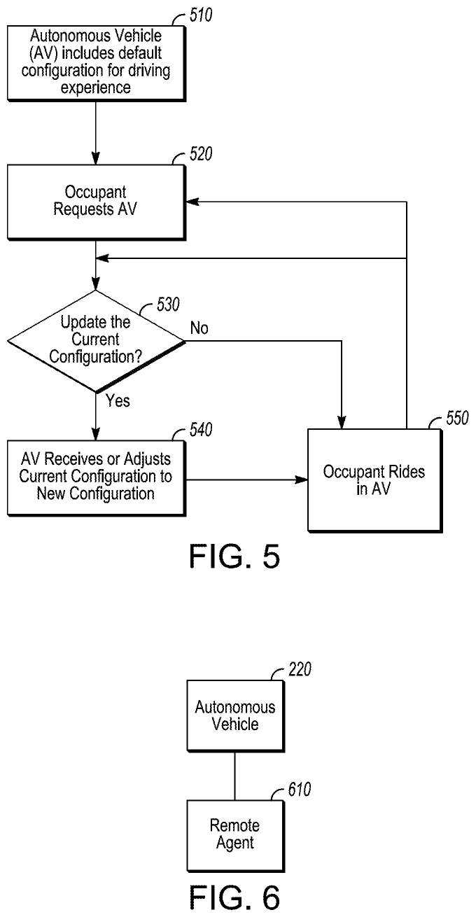

FIG. 5 illustrates a flowchart of a method according to one or more embodiments. As shown in FIG. 5, the method may begin with, at 510, an autonomous vehicle including a default configuration with respect to driving style. This may include parameters such as fuel efficiency, braking speed, maximum acceleration, following distance, road choice preferences, and the like.

The method may also include, at 520, an occupant making a request of the autonomous vehicle. The occupant may make the request before or after entering the autonomous vehicle. For example, the occupant may use a mobile app to request an autonomous vehicle. As another alternative, the occupant may board the autonomous vehicle and may make the request upon boarding. This request may be explicit or implicit and may be communicated directly to the autonomous vehicle or via a user device and/or remote server to the autonomous vehicle, as outlined in the examples above. Similarly, the request may deal with one or more aspects of the configuration. For example, the request may simply identify a destination and target arrival time. Alternatively, the request may indicate a preference for comfort. The occupant may say, “I have a terrible hangover, please don't make my headache worse.” Accordingly, the autonomous vehicle may optimize the drive based around minimizing acceleration/deceleration forces to the occupant and/or avoiding noisy construction sites.

The method may further include, at 530, determining whether to update a current configuration of the autonomous vehicle. This current configuration may be, for example, a default configuration or a configuration most recently applied by occupants of this particular autonomous vehicle. The determination may be based on a comparison of the occupant request to the current configuration.

If the current configuration should be changes to accommodate the request, then at 540 the autonomous vehicle may receive (for example from a user device or a remote server) or self-adjust a current configuration to a new configuration. The occupant may then, at 550, ride in the autonomous vehicle based either on the new configuration or, if a new a configuration was not needed, based on the current configuration.

The method may then loop back to 530 or 520 to wait to see if there is a need to update the current configuration or to wait to see if there is a new occupant request. Thus, in certain embodiments, the driving configuration may be updated during the drive even after an initial adjustment to the configuration was made.

The autonomous vehicle may include artificial intelligence (AI), such as machine learning (ML), to determine an occupant's likes and dislikes. While the Al/ML may have an initial default starting configuration, the Al/ML may learn before, during, and after each ride. The AWL system may be able to artificially adjust the default starting configuration. Over time, one autonomous vehicle may have a different ride experience/characteristic than another autonomous vehicle based on the AI/ML and feedback provided by the occupant(s).

An occupant may specify whether the occupant prefers a new or an experienced autonomous vehicle. For example, an occupant may request an autonomous vehicle from a pool of autonomous vehicles that have a variety of experience levels. Alternatively, the occupant may request that a given autonomous vehicle (perhaps an autonomous vehicle owned by the occupant) be loaded with a configuration used by an experienced autonomous vehicle.

An occupant may have a given profile of X. A system may search from a pool of autonomous vehicles to identify whether any match the profile of X, such as in regard to default configuration, or those that closely match the profile of X, within some threshold. In this case, the profile X may have a minimum performance standard. For example, the profile may specify a minimum 0 to 60 mph performance. If only non-compatible autonomous vehicles are available, the system can provide feedback to the occupant indicating that the occupant may have to either wait or adjust/fallback to another profile.

An occupant may specify performance type. For example, an occupant may request to have maximum acceleration and deceleration, rapid lane changes, and high speed cornering. An occupant may set preferences for traits such as stopping, accelerating, speeding, passing, route, and so on.

An occupant may provide feedback in a variety of forms, such as audible, visual, haptic (such as clutching a handlebar or steering wheel), and so on. An occupant may specify preferences in checklists or interfaces. For example, during an initial configuration or periodically an autonomous vehicle may query the occupant regarding driving preferences in order to elicit a response. Alternatively, or in addition, the autonomous vehicle may be configured to permit a user to provide feedback, change requests, or the like at the user's own initiative, for example through a user interface.

The autonomous vehicle may learn preferences in a dynamic and adaptive fashion. For example, if an occupant felt that the autonomous vehicle took too long to accelerate from a stoplight, then the occupant could provide that real-time or near real-time feedback. The feedback may be audible or through data. For example, the autonomous vehicle may come equipped with a rating device that may be used throughout the duration of a ride. This may be selectively used or continuously used. Alternatively, the occupant may provide such selective or continuous rating based through the occupant's device, like a smartphone in communication with a vehicle.

The above-described user input mechanisms may also be used for additional purposes. For example, in certain cases an autonomous vehicle may issue an alert that an occupant does not understand. The autonomous vehicle may, for example, determine that a sensor is in a fault condition. Thus, the autonomous vehicle may generate an alert to the occupant to indicate this fault. However, the alert alone may raise questions regarding the meaning, severity, or next steps to be taken. For example, the occupant may have additional questions such as the following: “Will this interrupt my ride?” “Will I reach my destination on time?” “Am I safe?” or “Do I need a new vehicle?”

Additionally, questions may arise to a user of the autonomous vehicle even in the absence of an alert. For example, an occupant may have a question regarding the operation or maintenance of the autonomous vehicle. The occupant may, for instance, have a question regarding the heating, ventilation, and air conditioning (HVAC) system, audio system, video system, connectivity system, or any other system. The occupant may not know how to operate the system, may not know what functionality the system offers, or the like. Similarly, the occupant may need instructions on how to charge, fuel, or otherwise maintain the vehicle.

Moreover, as mentioned above, the occupant may want to provide feedback, such as feedback related to ride experience or performance of the vehicle. For example, the occupant may want to indicate that the autonomous vehicle is taking too many unnecessary risks, is going too fast, is accelerating too quickly, is not braking soon enough, or the opposite, and so on.

As another example, an autonomous vehicle may indicate that an obstacle or other object was detected, and the occupant may determine that autonomous vehicle has erred in its object detection. Similarly, an autonomous vehicle may depart from a lane, and an occupant may therefore seize control of the vehicle and wish to provide feedback regarding the lane departure.

To address the above issues, or for other reasons, one or more embodiments may permit a process or processor of an autonomous vehicle, such as a process or processor of an autonomous driving controller to communicate with a local or remote agent. The local agent may be another process or processor running within the vehicle, such as another process running within the autonomous driving controller or on another processor of the autonomous vehicle. The remote agent may be a process or processor of a server that is physically separate from the autonomous vehicle, such as a cloud server.

The remote agent may be provided, in one or more embodiments, by a live person or AI system. The remote agent may be passive, selective, or fully active. The passive system may be a system that is waiting for an occupant to inquire, but which is not taking proactive steps. The selective system may proactively reach out to the occupant if a determination is made that such outreach is warranted. The fully active system may periodically or continuously reach out to the occupant.

FIG. 6 illustrates an architecture including a remote agent according to one or more embodiments. As shown in FIG. 6, the remote agent 610 may be physically separate from, but in communication with, autonomous vehicle 220. Thus, the remote agent 610 may be equipped with communication hardware and software and may be equipped to receive messages from autonomous vehicle 220. The remote agent 610 may also be equipped to receive data from the occupant(s) of autonomous vehicle 220 in other ways. For example, occupants may call or otherwise communicate with the remote agent 610 using a smart phone or other personal device.

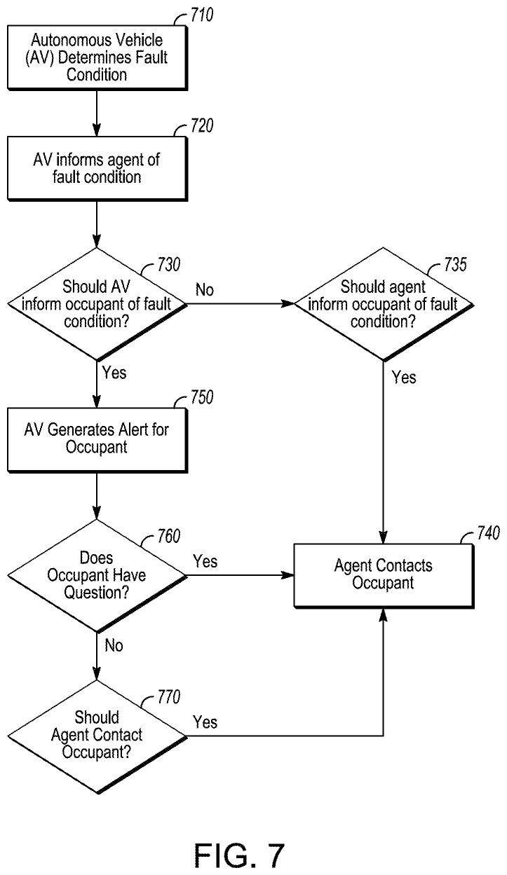

FIG. 7 illustrates a flowchart of another method according to one or more embodiments. As shown in FIG. 7, a method may include, at 710, an autonomous vehicle determining that a fault condition exists. The autonomous vehicle may, at 720, inform an agent of fault condition. The agent may be a remote agent, as described above.

At 730, the autonomous vehicle may determine whether to inform the occupant(s) of the vehicle of the fault condition. This determination may be made autonomously by the autonomous vehicle or may be made based on instructions from the agent. The determination may be made based on a configuration of the autonomous vehicle. If the determination is that the autonomous vehicle should not inform the occupant, a further determination may be made about whether the agent should inform the occupant about the fault condition, at 735. If so, then at 740 the agent may contact the occupant.

If the autonomous vehicle should inform the occupant of the fault condition, the autonomous vehicle may generate a suitable alert at 750. This alert may be an audible alert, a visual alert (such as a notification on a display screen), or a message to a personal device of the occupant, such as a text message to phone of the occupant. At 760, the autonomous vehicle may determine whether the occupant has a question or feedback regarding the alert. If so, an agent may contact the occupant at 740. If not, the autonomous vehicle may, at 770, make a further determination regarding whether the agent should nevertheless contact the occupant. If so, the agent may contact the occupant at 740. Otherwise, the method may simply revert to waiting for a new fault condition to arise.

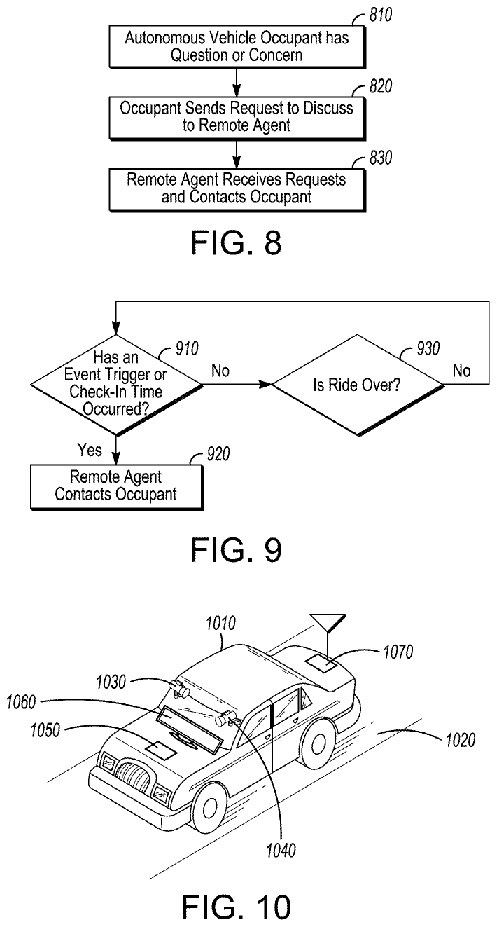

FIG. 8 illustrates an occupant-initiated request method, according to one or more embodiments. As shown in FIG. 8, at 810 an autonomous vehicle occupant may have a question or concern regarding the autonomous vehicle. Accordingly, at 820, the occupant may send a request to a remote agent to discuss the question or concern. This request may be sent through the autonomous vehicle or by a separate channel, such as through a personal device of the occupant.

When sending the request, the occupant may select an urgency level, such as low, medium, or high urgency. When the remote agent receives the request, at 830, the remote agent may triage requests by the urgency level, or may simply contact the occupant in the order in which the request was received. Other systems and techniques for responding are also permitted. For example, the remote agent may take into account how long an occupant has been waiting for a response in giving priority to an occupant's request.

The remote agent may also implement additional or alternative triaging steps, such as analyzing the content of the request. The content of the request may include text, audio, video, sensor data of the autonomous vehicle, a set of current fault conditions of the autonomous vehicle, or the like. If the request is sent in all caps, if the request contains certain trigger words associated with a negative experience, if the audio shows high stress or indicates panic or scare, or if the video indicates a particular emotional or physical state of the occupant, priority of the request may be appropriately judged. For example, indicators of intoxication or other disabling factors may be used to give priority to a request from the occupant.

FIG. 9 illustrates a remote-agent-initiated request method according to one or more embodiments. As shown in FIG. 9, at 910 the remote agent may be aware of an occupant's ride in an autonomous vehicle, and may determine whether an event trigger or check-in time has occurred. If so, then the remote agent may contact the occupant at 920. Otherwise, the remote agent may determine whether the ride is over at 930. If the ride is over, the method may end. Otherwise, the method may revert to 910 so that the remote agent may continue checking whether an event trigger or check-in time has occurred.

At times, it may be beneficial for a remote agent check in with the occupant of the autonomous vehicle. This may be based on the occupant's preferences, such as a user profile. As an alternative, this may be based on ride duration, such as by distance or time. The remote agent may schedule check-ins based on time, distance, and/or other counters. For example, early on, a ride share system may be more active in checking in, as the occupant gets comfortable and situated in the autonomous vehicle. This may be to complete an initial questionnaire, such as on comfort level. The questionnaire may ask questions about the audio level (too loud?), the radio station (correct genre?), the temperature (too hot? too cold?), or the like.

While a fault condition may not have occurred, the occupant may want the autonomous vehicle to adjust its operation. This may be done through the remote agent. In one or more embodiments, this same approach may be performed by a local agent rather than by a remote agent.

The autonomous vehicle may include a system for communicating with a remote agent. This may involve a controller or other processor and transceiver. The autonomous vehicle may include one or more onboard mics, for an occupant to state and possibly record a request for the remote agent. The autonomous vehicle may include a processor for receiving the audio input and possibly converting the audio input into a different format. The autonomous vehicle processor may provide a signal based on the audio input to be transmitted to the remote agent.

The autonomous vehicle may include a text system, audio system, and/or a video system. The video system may analyze the occupant's facial expressions, such as for mood, wakefulness, alertness, or the like.

In a further scenario, the autonomous vehicle may detect a particular occupant via facial recognition and update the configuration accordingly. For example, if someone hails a ride, the autonomous vehicle may recognize that the occupant who hailed the ride is X. Based on past experience with X, the autonomous vehicle may configure itself accordingly and/or ask/confirm whether the occupant is X and/or whether the autonomous vehicle should be configured according to a corresponding configuration.

Utilizing the remote agent may free up the autonomous vehicle from having to store or generate responses to requests or the like using an onboard processor. In certain cases, a local agent may supplement the remote agent, either to address simpler concerns, or to provide a more rapid response or fallback, in case a remote system is unavailable or slow. The remote agent may free up computing power in the autonomous vehicle for other purposes.

The remote agent may include a system for communicating with the autonomous vehicle. The remote agent may include a transceiver for communicating. The remote agent may include one or more remote servers and one or more remote processors and memory. The remote agent may include Al, such as ML, or other SW to triage, escalate, and respond to requests. A ticketing system may be used to assist the process.

The remote agent may include a live person to triage, escalate, and respond to requests. The remote agent may process signals to analyze textual context, audio context, and/or video context.

The remote agent may respond to fault conditions in the autonomous vehicle, may respond to user-initiated questions, and may selectively or actively respond to trigger events or time intervals.

Through the remote agent, the occupant may receive insight on fault conditions, answers to user-initiated questions, or otherwise have a ride experience to the occupant's desires. The occupant may provide real-time feedback, which the remote agent may analyze to adjust the performance of the autonomous vehicle.

The remote agent may improve the occupant's experience in the autonomous vehicle. The remote agent may make the experience more interactive or informative. The occupant may disable the remote agent's interaction or may otherwise decline interaction with the remote agent.

According to one or more embodiments, a machine-implemented method may include receiving a configuration for an autonomous vehicle. This configuration may be received at the autonomous vehicle itself, by a controller of the autonomous vehicle. The controller may receive the configuration through an interface as part of the initial configuration of the controller (for example, in a factory setting), or the configuration may be loaded wirelessly or otherwise through an interface. For example, the configuration may be received using a transceiver. Alternatively, the configuration may be obtained through querying an occupant of a vehicle upon start-up of the vehicle. The configuration may be stored in memory, which may be any suitable computer-readable medium.

The method may also include operating the autonomous vehicle based on the configuration. This operating may be performed by the controller. The operating may broadly encompass causing the vehicle or any of the vehicle's components or sub-components to perform an action. In a specific example, the operating may involve driving the vehicle autonomously including any or all of the actions associated with autonomous driving. The method may further include receiving or otherwise obtaining, after the operating, an update to the configuration. For example, instead of receiving the update from an external source, the controller may generate the update itself. This receiving may be performed through a transceiver of the autonomous vehicle or through another interface, such as through a user interface. The method may additionally include further operating the autonomous vehicle based on the update. The further operating may be performed by the controller. This process may be cyclical. Thus, for example, the update may be subsequently updated.

The method may further include receiving feedback regarding the operating via an interface. This may be via a user interface or via a transceiver. For example, the transceiver may receive the feedback via a remote server. As another alternative, the receiving feedback itself may happen at a remote server. The method may also include generating the update based on the feedback. This generating may be done locally by the controller or remotely by a remote server.

The feedback may include explicit feedback, implicit feedback, or a combination thereof. As mentioned above, various input devices and sensors may be used to illicit feedback from a vehicle occupant or other stakeholder. For example, a non-occupant owner may also provide feedback.

The implicit feedback may include facial expression, posture, gripping, or a combination thereof by an occupant of the autonomous vehicle. The feedback (whether explicit or implicit) may include text input, tactile sensor input, audio input, or any combination thereof by an occupant of the autonomous vehicle.

The update may be received over-the air, hardwired, via a user equipment, or any combination thereof. Examples of user equipment may include smart phones, smart watches, tablets, or the like.

The configuration may be user-specific. Also, or alternatively, the update may be user-specific. As another option, the configuration and/or update may be group-specific. The group may be an enterprise organization, such as a ride sharing company.

The configuration may include various profiles. For example, the configuration may include a performance profile and an economy profile. A performance profile may emphasize speed at the expense of other factors, such as wear and tear on the vehicle. An economy profile may emphasize fuel efficiency at the expense of other factors, such as acceleration.

The method may include receiving a driving preference from an occupant of the autonomous vehicle. This preference information may be received by any suitable input mechanism directly from the occupant or relayed through a remote server. The method may also include generating the update based on the driving preference. As mentioned above, the generating may be performed locally or remotely.

The driving preference may include a fuel usage preference, a speed preference, a toll preference, any combination thereof, or any other desired preference.

The configuration may configure behavior of the autonomous vehicle with respect to acceleration from stoplights, with respect to following distance, with respect to deceleration, with respect to cornering, any combination thereof, or any other desired behavior of the autonomous vehicle.

A further method may include operating an autonomous vehicle. As with the operating discussed above, this operating may be performed by a controller. The method may also include receiving feedback from an occupant of the autonomous vehicle regarding the operation. This feedback may be received locally at the autonomous vehicle or remotely, for example, by a remote agent. The method may also include responding to the occupant regarding the feedback. The responding may be done locally by the autonomous vehicle or remotely by a remote agent.

The operating may further include generating an alert by an autonomous vehicle. This alert may be generated by a presentation device, such as a speaker, display, haptic feedback, or the like. The feedback from the occupant may include a request for further information regarding the alert.

The feedback may include a query regarding a system or component of the autonomous vehicle. The feedback may also or alternatively include a complaint regarding operation of the autonomous vehicle. The complaint may, for example, identify an error in the operation of the autonomous vehicle. Also or alternatively, the complaint may identify a desired change in configuration of the autonomous vehicle.

The responding may be based on communicating with a remote agent. Thus, for example, a remote agent may provide information to the autonomous vehicle or directly to a vehicle occupant. As mentioned above, a remote agent may be or include a remote computer system. This remote computer system may implement or include a knowledgebase and may utilize artificial intelligence and/or machine learning.

FIG. 10 generally illustrates a vehicle according to the principles of the present disclosure. As shown in FIG. 10, a vehicle 1010 can be configured to operate on road 1020. Operating on the road 1020 can include performing fully or partially autonomous driving on the road. Operating on the road 1020 can include using engine controls (for example, throttle controls), steering controls, and braking controls to control the location, speed, and acceleration of the vehicle. Various tools and techniques for autonomous driving are permitted.

The vehicle 1010 can be equipped with a right internal camera 1030 and a left internal camera 1040, which may be visible and/or infrared wavelength cameras. Other sensors are permitted, and the number of cameras can be greater or fewer than two. Data from the sensors may be received at a controller 1050, which may include computer hardware and computer software. The controller 1050 may also be connected to a human-machine-interface (HMI) such as a graphical user interface (GUI)) 1060. The vehicle 1010 may also include a transceiver 1070 configured to communicate with other vehicles, road infrastructure, a remote server, or any other desired device.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Various terms are used to refer to particular system components. In the above discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Controller” may refer to individual circuit components, an application-specific integrated circuit (ASIC), a microcontroller with controlling software, a digital signal processor (DSP), a processor with controlling software, a field programmable gate array (FPGA), or combinations thereof.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein may be realized in hardware, software, or any combination thereof. The hardware may include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module may include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module may include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module may include memory that stores instructions executable by a controller to implement a feature of the module.

Further, in one aspect, for example, systems described herein may be implemented using a general-purpose computer or general-purpose processor with a computer program that, when executed, carries out any of the respective methods, algorithms, and/or instructions described herein. In addition, or alternatively, for example, a special purpose computer/processor may be utilized which may contain other hardware for carrying out any of the methods, algorithms, or instructions described herein.

Further, all or a portion of implementations of the present disclosure may take the form of a computer program product accessible from, for example, a computer-usable or computer-readable medium. A computer-usable or computer-readable medium may be any device that may, for example, tangibly contain, store, communicate, or transport the program for use by or in connection with any processor. The medium may be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A system for an autonomous vehicle, the system comprising:
an interface configured to receive a configuration for the autonomous vehicle; and
a controller configured to operate the autonomous vehicle based on the configuration,
wherein the controller is configured to obtain an update to the configuration and to operate the autonomous vehicle based on the update.

2. The system of claim 1, wherein the controller is further configured to receive feedback from at least one sensor regarding the operating and configured to obtain the update by generating the update based on the feedback.

3. The system of claim 2, wherein the feedback comprises explicit feedback, implicit feedback, or a combination thereof.

4. The system of claim 3, wherein the implicit feedback comprises facial expression, posture, gripping, or a combination thereof by an occupant of the autonomous vehicle.

5. The system of claim 2, wherein the feedback comprises text input, tactile sensor input, audio input, or any combination thereof by an occupant of the autonomous vehicle.

6. The system of claim 1, wherein the controller is configured to obtain the update by receiving the update over-the-air, hardwired, via a user equipment, or any combination thereof.

7. The system of claim 1, wherein the configuration is user-specific, the update is user-specific, or both the configuration and the update are user-specific.

8. The system of claim 1, wherein the configuration is group-specific, the update is group-specific, or both the configuration and the update are group-specific.

9. The system of claim 1, wherein the configuration comprises a performance profile and an economy profile.

10. The system of claim 1, wherein the controller is configured to receive a driving preference from an occupant of the autonomous vehicle and generate the update based on the driving preference.

11. The system of claim 10, wherein the driving preference comprises a fuel usage preference, a speed preference, a toll preference, or any combination thereof.

12. The system of claim 1, wherein the configuration configures behavior of the autonomous vehicle with respect to acceleration from stoplights, with respect to following distance, with respect to deceleration, with respect to cornering, or any combination thereof.

13. A system for an autonomous vehicle, the system comprising:
a controller configured to operate the autonomous vehicle; and
an interface configured to receive feedback from an occupant of the autonomous vehicle regarding the operation,
wherein the controller is configured to respond to the occupant regarding the feedback.

14. The system of claim 13, wherein the operating comprises the controller generating an alert to be transmitted from the autonomous vehicle.

15. The system of claim 14, wherein the feedback comprises a request for further information regarding the alert.

16. The system of claim 13, wherein the feedback comprises a query regarding a system or component of the autonomous vehicle.

17. The system of claim 13, wherein the feedback comprises a complaint regarding operation of the autonomous vehicle.

18. The system of claim 17, wherein the complaint identifies an error in the operation of the autonomous vehicle.

19. The system of claim 18, wherein the complaint identifies a desired change in configuration of the autonomous vehicle.

20. The system of claim 13, wherein the responding is based on communicating with a remote agent.
